(19) United States
(12) Patent Application Publication
(10) Pub. No.: US 2026/0225917 A1
(43) Pub. Date: Aug. 6, 2026

(54) Systems and Methods for Stormwater Treatment

(71) Applicant: GeoStorage Corp., Rumson, NJ (US)

(72) Inventor: Terence G. SHERIDAN, Rumson, NJ (US)

(21) Appl. No.: 19/043,849

(22) Filed: Feb. 3, 2025

(51) Int. Cl. C02F 1/00; B01D 15/10; B01D 24/20; C02F 1/28; C02F 3/32; C02F 103/00

(52) U.S. Cl. CPC C02F 1/004; B01D 15/10; B01D 24/205; C02F 1/28; C02F 3/327; B01D 2101/04; C02F 2103/001

(57) ABSTRACT

Improved water quality treatment systems and methods are provided comprising permeable and stabilized chamber(s) and trench(es) that facilitate the removal of pollutants from water. In embodiments, the system includes a permeable, subsurface inlet forebay chamber formed by a stabilized perimeter filter media which removes pollutants and provides structural, operational, environmental, and economic benefits in a small footprint. A permeable, subsurface outlet chamber and trench stabilized by similar methods are optional features of the system.

### FIELD

Embodiments of the present disclosure generally relate to stormwater treatment systems and methods for removing pollutants.

### BACKGROUND

Stormwater treatment systems are a feature in stormwater management systems and are often designed in tandem with stormwater retention/detention systems. The purpose of stormwater treatment systems is to improve the water quality either flowing to downstream water bodies or infiltrating into the subgrade.

During a rain event, pollutants deposited on the surface of a watershed are often designed to drain to the nearest stormwater management inlet. Stormwater treatment systems are designed to remediate the “first flush” or earliest stage of the storm event, the stormwater quality design storm (SWQD), where the pollutant load is most concentrated.

Green Infrastructure (GI), often referred to as low impact development (LID), can infiltrate stormwater into the subsoil or treat stormwater runoff (influent) through filtration by vegetation or soil and transport the treated runoff (effluent) downstream. Stormwater runoff infiltrated directly into the subgrade can be treated by filtration as well as biological and chemical activity in the soil.

Filtration rain gardens, also referred to as biofiltration, bioretention, or vegetated basins utilize a filter media augmented by vegetation. In addition to physical and chemical processes, filtration rain gardens incorporate biological treatment which is self-sustaining. Plants and their root systems can remove and process pollutants such as nutrients and metals that are not effectively captured and processed by physical and chemical filtration.

In some cases, stormwater runoff infiltrated directly into the subgrade is considered an acceptable level of treatment. In other cases, it is treated by a filtration rain garden before infiltrating into the subgrade. Treated stormwater may also be transported downstream. In these cases, the treatment process may have a vegetation component. It is common for filtration rain gardens to partially infiltrate stormwater into the subgrade and transport treated stormwater downstream simultaneously.

Some rain gardens may include a collection and conveyance system below the filter media to increase storage capacity and to transport treated stormwater downstream. This system is usually positioned above the water table and the downstream outlet invert to enable gravity flow. The available profile height is limited by these constraints.

Stormwater flows vertically through the layers of a traditional rain garden (mulch, planting bed, filter media, collection/conveyance system), often piped to a downstream detention system for flood control. Inflow of stormwater is limited to the surface area of the rain garden where pre-treatment options are limited. Stormwater runoff piped underground from upstream sources may be difficult to outlet to the surface of a rain garden. Traditional drainage and grading plans transport stormwater in pipes below the surface grade. Surface grades, pipe grades and inlet manhole invert elevations are adjusted to enable gravity flow. The inability of surface rain gardens to accommodate subsurface pipes complicates upstream grading and drainage designs.

Stormwater treatment systems are proposed that can improve pollutant removal performance, provide design options for different levels of pollutant removal, extend the service life, simplify construction and maintenance operations, reduce the required footprint and enable an efficient storage/detention component at a low cost.

### SUMMARY

Systems and methods for stormwater treatment are described herein.

In some embodiments, the stormwater treatment system comprises an underground chamber acting as a forebay for the distribution of untreated or partially treated stormwater through the stabilized and permeable chamber walls and into a filter media for pollutant removal. Stormwater flowing through the forebay can act in tandem with infiltration through a rain garden planting bed. The filter media encompasses and defines the walls of the forebay. The chamber walls are stabilized outside of the forebay. The forebay acts as a sedimentation pool and may, in some embodiments, enable the installation of pretreatment materials and mechanisms within the forebay chamber, such as filter media granules and materials and catch basin inserts.

In some embodiments, the forebay may be accessible for inspection and maintenance crews and allows for flow (e.g., radial flow) through the filter media. The forebay chamber walls may be geosynthetic reinforced structures (GRS) with the geosynthetic reinforcement layers installed within the filtration media. Geogrid reinforcement may enable unobstructed flow and entangle with the vegetation roots to improve wall stability and erosion control.

In some embodiments, the face the of forebay chamber wall may be constructed as a “wrap face” with apertures from the main reinforcement layer or an inserted facing layer sized to optimize performance. In some embodiments, a replaceable filter screen may provide a longer service life and simplified maintenance operation. The aperture opening size and characteristics of the “wrap face” may vary with height.

In some embodiments, an inlet grate or manhole cover and their respective frames and related loads (e.g., AASHTO HS-20 Truck Loads) may be supported by the forebay walls. In some embodiments, a plurality of forebay chambers as described herein might be used in one stormwater treatment system to accommodate surface inlet grates and/or pipes from upstream sources. In some embodiments, an overflow pipe may be installed within the forebay or rain garden surface pond to direct “clean” water downstream after the required water quality design storm (WQDS) volume has been treated.

In some embodiments, an inlet pipe may be directed into the forebay below the surface grade, which can provide greater design flexibility and can reduce the cost of the grading operation.

As described in greater detail herein, the stabilized, permeable, subsurface forebay is configured to bottom feed vegetation roots in the rain garden with water and oxygen.

In some embodiments, an outlet chamber may be constructed in the same fashion as discussed above and have stabilized walls. The outlet chamber may be located within a rain garden pond and provide overflow with an inlet raised to the WQDS elevation as is common for overflow pipes. In some embodiments, the outlet chamber may be located within the perimeter storage/infiltration region. In some embodiments, a pipe may be installed in the outlet chamber to direct treated stormwater downstream. Stormwater can flow through the filter media and perimeter storage/infiltration region before entering the outlet chamber. In some embodiments, the stormwater treatment system may include an inlet forebay(s) and outlet chamber(s).

In some embodiments, the WQDS volume of stormwater can infiltrate from the stormwater treatment system into the surrounding subgrade. However, the infiltration rate of the subgrade may be lower than surface infiltration, even before adding in potential stormwater piped into the forebay. Enlarging the system footprint and increasing the storage capacity are some methods that can facilitate the infiltration of the WQDS volume.

In embodiments, flow from the inlet forebay is radial and outward. In embodiments, a storage/infiltration region may extend beyond the perimeter of the filtration media increasing the infiltration area and/or storage volume while also providing an additional, but lower, level of pollutant removal. In some embodiments, an outlet chamber may be installed within the stone bed to transport stormwater downstream. A lateral extension of the storage/infiltration region can offer spatial, construction and economic advantages over an infiltration/storage/conveyance system located beneath the filter media.

In some embodiments, no perforated pipes are installed to transport, collect, or distribute stormwater into, through or out of the filter media. Lateral flow combined with the filter media particulates of a selected gradation transport stormwater within the system. Flow through the filter media, as opposed to pipes, increases the pollutant stripping and total pollutant load capacity of the stormwater treatment system. In some embodiments, pipes may be included where additional flow is desired or where pipes reduce the flow length through the filter media.

In some embodiments, a single uniform filter media gradation may provide the required pollutant removal and flow rate.

In some embodiments the gradation of the filter media immediately surrounding the forebay in a pretreatment pollutant removal region may have larger particles with larger pores and higher hydraulic conductivity that would be less likely to occlude. The pretreatment pollution region may provide a lower level of pollutant removal.

Beyond the perimeter of the pretreatment removal region, smaller filter media particulates in a primary pollutant removal region may be installed that have a higher surface area and tortuosity which may improve pollutant removal.

In some embodiments, stone or sand may be installed in the storage/infiltration region located beyond the perimeter of the primary pollutant removal region. Within the storage/infiltration region additional storage volume may be provided by pipes, chambers, plastic modules concrete vaults. or other stormwater containers. The storage/infiltration region may provide a lower level of pollutant removal while expanding the infiltration area and providing storage and transporting the stormwater to the outlet chamber.

Increasing the length/radius of the pretreatment removal region may decrease the pollutant load reaching the primary pollutant removal region. More importantly, the interface surface area between the two regions may also increase. As a result, the pollutant load may spread across a much larger surface area of the primary pollutant removal region face. The width, height and gradation of the pretreatment pollutant region and the primary pollutant removal region may be optimized for at least one of pollutant removal, pollutant loading, flow rate, or economics.

In some embodiments, the primary pollutant removal region may be stabilized on one or both sides by perimeter reinforcements like the methods used for the forebay and outlet chamber. In some embodiments, the primary pollutant removal region may additionally or alternatively be internally stabilized with screens on both sides separating the adjacent regions. The stabilized, permeable, subsurface cavity can simplify replacement of the primary pollutant removal media.

In addition to the pollutant removal benefits of the backfill configuration discussed above, the stability of the forebay, outlet chamber, and primary pollutant removal region trench walls may improve with a larger backfill that has a higher permeability. Filter gradation design criteria are applicable to the interface of all dissimilar materials within the stormwater treatment systems described in accordance with the present disclosure and where stormwater enters those systems, including where geogrids, geotextiles, screens, meshes and similar filters are installed.

In some embodiments, where surface ponding is included in the rain garden design, the elevation of the inlet forebay may be adjusted to coordinate pollutant loading between the rain garden surface and the forebay(s). A raised forebay inlet may allow saturation of the planting bed region and deposition of sediment before stormwater flows into the forebay. A depressed forebay inlet may accept early-stage inflow with higher and potentially more damaging pollutant loads, such as salts, hydrocarbons, and metals, which can be treated in the forebay rather than being deposited on the plant bedding surface.

Inlet grate covers may restrict the movement of larger trash from entering the forebay. In some embodiments, where the rain garden is designed with a surface pond, the elevation of the outlet chamber inlet may be set to capture overflow after the WQDS volume has been treated. The inlet forebays and outlet chambers may be configured to provide access for inspection and maintenance crews.

In some embodiments, mulch and stone may be placed on the surface of the rain garden for filtration, moisture retention, weed suppression and aesthetics. Erosion control measures, such as rip rap channels, may be utilized to preserve the integrity of the surface and promote sedimentation. The upper layer of the filter media may be designed to promote the establishment of vegetation in the planting bed region and provide a transition filter zone between two regions with different gradations.

In some embodiments, volume outlet control measures, such as a weir with orifices in the downstream outlet control system (OCS) may be used to extend the residence time of the stormwater, enable draw down within regulated time periods, and meet stormwater “quantity” control regulations.

Other and further embodiments of the present disclosure are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1 is an elevation view illustrating a stormwater treatment system with a singular filter media region according to some embodiments of the present disclosure.

FIG. 2 is a plan view of the system shown in FIG. 1.

FIG. 3 is an expanded elevation view of the forebay chamber with multiple filter media regions.

FIG. 4 is an elevation view illustrating a stormwater treatment system according to some embodiments of the present disclosure.

FIG. 5 is a plan view of the system shown in FIG. 4.

FIG. 6 is an elevation view illustrating a stormwater treatment system according to some embodiments of the present disclosure.

FIG. 7 is a plan view of the system shown in FIG. 6.

FIG. 8 is an elevation view illustrating a stormwater treatment system according to some embodiments of the present disclosure.

FIG. 9 is a plan view of the system shown in FIG. 8.

FIG. 10 is a plan view illustrating a stormwater treatment system according to some embodiments of the present disclosure.

FIG. 11 is an elevation view of the filter media regions with an alternate configuration to that shown in FIG. 3.

FIG. 12 is an elevation view of the filter media regions with an alternate configuration to that shown in FIG. 3.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

Embodiments of stormwater treatment systems, also referred to herein as stormwater quality treatment systems, are provided herein. The size and configuration of the stormwater treatment system will be influenced by the water quality design storm (WQDS) volume, filter media flow rate, subgrade permeability, available profile height, level of pollutant removal along with the stormwater detention volume when included.

In embodiments, an inlet forebay is constructed within a stormwater quality treatment system that extends towards the subgrade soil. In some embodiments, an inlet grate above the forebay is configured to filter trash. The forebay creates a subsurface void within the stormwater treatment system. Filter media may be placed around the perimeter of the forebay void and stabilized with reinforcements. The forebay provides a sump for filtration of pollutants by sedimentation. The forebay enables subsurface lateral flow into the filter media and increases the sediment loading surface area for untreated stormwater entering the filter media above that provided strictly by the surface area.

The walls of the forebay may be less susceptible to compaction and occlusion than the surface of the rain garden. The forebay may also be sized to house additional pretreatment filtration systems within its volume which may provide superior pollutant removal than available for overland surface flow into the surface element of a rain garden. In some embodiments, catch basin insert filter screens and filter media products targeted for specific pollutants may be suitably employed. In some embodiments, replaceable filter screens may be employed on the forebay chamber walls. In some embodiments, the inlet forebay may be configured to aerate the filter media and “bottom water” the planting bed region. Aeration and bottom watering promote healthy, strong and deep roots. In some embodiments, the forebay may be configured to enable access for inspection and maintenance crews to observe and remediate the sediment loading surface within the forebay directly. In some embodiments, the forebay may also be configured to enable a backflushing operation to collect sediment from the surrounding filter media.

In embodiments, the walls of the forebay may be stabilized by reinforcement materials within the filter media to support the walls and overlying surcharges. The reinforcement materials may be geogrids or geotextiles that will not compromise flow through the filter media. In some embodiments, the reinforcement may be extended up the face of the wall to retain the filter media in the fashion of “wrap face” retaining walls. In some embodiments, the “wrap face” at the face of the forebay wall may be augmented by screens with smaller openings to aid in filtration. In some embodiments, inclusions may also transport or wick water from the forebay into the filter media backfill. The inclusions may be formed from geosynthetic materials having an open mesh structure.

Other perimeter wall stabilization construction methods include geocells, geocellular structures and gabions adapted to support wall pressures and surcharge loads.

The filter media backfill enveloping the inlet forebay has many functions and properties. Filter media can remove pollutants. In vegetated rain gardens filter media also can support the root system of the vegetation. Sorbtive properties of the filter media can play an important part in the health of the vegetation and pollutant removal. The friction angle and structural properties of the filter media particulates are important considerations in the design of the forebay walls. In some embodiments, the filter media may be comprised of vegetation, soils, aggregates, organics, vitrified ceramic, expanded shale, clay or slate (ESCS), ultra-lightweight foamed glass aggregates (UL-FGA), mineral wool, tire crumb, biochar, and additives to optimize pollutant removal.

Fluid flow and retention facilitate the proper functioning of a rain garden. For example, in some embodiments, the stormwater treatment system drains sufficiently quickly to be functional for a subsequent rainstorm, e.g., typically in a 48-96 hour time frame. The health of the vegetation must balance too much water after large storm events and too little water during droughts. Residence time impacts pollutant removal and is a function of the flow rate. The stability of the forebay and outlet chamber walls may be subject to pore pressures which are a function of the flow rate through the filter media backfill. The foregoing factors may be considered and balanced in the design to optimize performance for a particular application.

The gradation of the filter media can impact flow rates, pollutant removal, pollutant surface loading area, tortuosity, filter stability at interfaces between dissimilar gradations, forebay and outlet wall stability, and vegetation health. Larger particles can increase the flow rate and friction angle. Smaller particles can increase the surface area and tortuosity.

Larger particles can increase the stability of the forebay and outlet chamber walls. Higher friction angles can decrease the lateral loads on the walls. Higher flow rates can decrease hydrostatic forces related to pore pressures. However, the high flow rate and low surface area can decrease the pollutant removal capacity of larger particles.

Smaller particles can decrease pore size and increase flow path lengths resulting in a more tortuous flow. Combining a tortuous flow with friction along the pore walls may result in higher pollutant removal. The higher surface area of smaller particles may increase the absorption and adsorption pollutant removal capacity of the filter media. In addition, the nutrients retained by absorption and adsorption supports the vegetation. However, filter media with smaller pores can be more susceptible to clogging.

One concern in rain garden designs is occlusion. Not only does clogging impede water quality functions, but it can also result in upstream flooding. The placement of larger particles around the forebay can increase chamber wall stability and can expand the critical pollutant loading surface at the interface with smaller particles placed beyond the perimeter of the larger particles. Larger filter media particulates placed around the perimeter of the forebay may provide lower pollutant removal through their length. However, as that length increases the surface area where the large particles interface with smaller particles expands. This larger pollutant loading surface area can reduce the potential for clogging. The expanded surface area at the interface with smaller particulates also can increase the available flow rate out from the inlet forebay. The travel length through the larger filter media particulates can act as a pretreatment mechanism. As the radius around the forebay increases, the volume of both large and small filter media particulates increases, which, in turn, increases the pollutant removal and pollutant load capacity of the stormwater treatment system. The large particulate area around the forebay also enables a more effective backflushing operation for maintenance.

The sensitivity of hydraulic conductivity highlights the challenges of an effective design. Medium sands can have a hydraulic conductivity 100× greater than fine sands. Coarse sands can have a hydraulic conductivity 100× greater than medium sands. The range of hydraulic conductivities with stone aggregates is even greater. Furthermore, compaction can reduce hydraulic conductivity 100×. Lastly, the plasticity of the filter media can also impact the hydraulic conductivity significantly. Traditional rain gardens target hydraulic conductivity in the 0.5-12 inches/hour range. “High Flow” filter medias promote hydraulic conductivity upwards of 100 inches/hour. This is a very tight window to construct and maintain over the service life. The stormwater treatment systems and methods in accordance with the present disclosure enhance the ability of the rain gardens to operate within this tight window of hydraulic conductivity.

Geotextiles have been outlawed in rain gardens by many regulatory agencies because of clogging concerns. Non-woven geotextiles have the same equivalent pore opening size as coarse sands (70-100 microns). Fine and coarse sand are often the predominant component of the filter media in traditional rain gardens. Theoretically, both coarse sand and non-woven geotextiles should clog at the same rate but, geotextiles have taken the brunt of the blame. Pollutant loads, pretreatment, filter design, geotextile selection, soil compaction, quality control measures and other factors all can play a role in clogging of the stormwater treatment system. In some embodiments, the placement of a geotextile filter on the face of the forebay wall may be another effective pretreatment mechanism. The geotextile type (woven monofilament vs non-woven) may reduce the potential for clogging. Geotextile meshes with openings as large as coarse sand and fine gravel particles may also be utilized. Also, maintenance crews can inspect and remediate the forebay wall face. Cleaning the forebay wall face is much easier with a highly porous media backfill. A vacuum can suck in finer particles, or a power washer can blow out the particles. In addition, a geotextile or fine screen that can be removed and replaced provides another maintenance friendly option at the forebay face.

Infiltration is another consideration in the stormwater management design. The infiltration rate and volume may be dependent on the permeability of the subgrade soil and the infiltration area. In some embodiments, an open graded stone bed can be installed at the perimeter of the filter media and extended laterally at the same floor and surface elevations. The extended perimeter may increase the infiltration footprint resulting in a larger infiltration and storage volume. Stormwater containers, like pipes, and vault chambers within the stone bed can augment the storage volume in the storage/infiltration region.

In some embodiments, perforated pipes to distribute inflows and outflows within the filter media may be eliminated. Radial flow from the inlet forebay and the resultant expanding flow area along with the gradation of the filter media particulates may enable the system to perform as required. The WQDS volume can be designed to drain in the required time. Radial flow may also distribute the influent over a larger area. As a result, flow paths may not be concentrated, exhausting the filter media along the flow paths to or from pipe perforations. This methodology also may encourage the use of a larger volume of filter media to aid in drainage which may increase the system's pollutant removal and load capacity.

Adjusting the rim elevations of the inlet forebays may facilitate optimization of pollutant removal, design life and maintenance requirements for the stormwater treatment system.

A raised inlet may direct water to the rain garden surface where even small storm events can saturate the planting bed region and vertical flow though the surface vegetation provides pollutant removal. The latter stage lateral flow from the forebay through the filter media, with a lower concentration of pollutants, may reduce the potential for clogging in this subsurface region. In some embodiments, a “weep hole” at the foundation of the raised inlet can slowly drain pond water if desired.

A depressed inlet may accept the initial pollutant laden influent. Multiple levels of water pretreatment may be applied to target large sediment loads and specific pollutants like salt, hydrocarbons, and metals. Removal of these pollutants from the forebay may simplify maintenance when compared to removing them from the rain garden surface. Vegetation roots may extend and uptake pollutants deposited in the filter media below the surface.

In some embodiments, treated stormwater may be collected in the storage/infiltration region and flow into the outlet chamber and be piped downstream from the outlet chamber. The outlet chamber may also be permeable and stabilized by reinforcement inclusions within the chamber wall backfill. Treated stormwater may flow into the outlet chamber though the chamber walls. In surface pond applications, the grate of the outlet chamber may act as an overflow by setting the inlet at the elevation corresponding to the WQDS volume.

In some embodiments, an impermeable geomembrane liner, or similar material, may be installed at the bottom of the forebay and outlet chamber to simplify future maintenance (e.g. a vacuum truck). In Infiltration applications, the geomembrane may be extended along the floor if infiltrated water requires pretreatment. Geomembranes may also be utilized to prevent “short-circuiting” the treatment flow path in certain areas and configurations to insure the WQDS volume is fully treated. A geotextile may be installed along the perimeter walls of the stormwater treatment system to prevent in-situ soil from piping into the system.

In some embodiments, and as shown in the drawings, a rain garden may include an interior inlet grate above the forebay. In some embodiments, the rain garden can be adapted for a curb inlet, as needed.

Pretreatment is important to the performance and service life of a rain garden. In some embodiments, the stormwater treatment system may use all the pretreatment tools available for surface rain gardens where appropriate: rip-rap channels, mulch, hay bales, filter socks. The forebay may allow for additional pretreatment tools, not available to surface infiltration, that may improve performance and extend service life including: an inlet grate stabilized on the reinforced media, a sedimentation sump, a catch basin insert, advanced specific pollutant targeting filter media within the forebay, filters and screens on the forebay walls, a removeable filter screen around the forebay walls. Large filter media particulates extending out from the forebay walls may also provide pretreatment along with increasing the interface area of a primary pollutant removal interface surface and enabling backflushing maintenance.

In some embodiments, pretreatment measures may be applied in upstream manholes for stormwater piped into the inlet forebay.

Most sediment and pollutants are collected in frequent small storms or the early stages of larger storms. Regulations target this “first flush” stormwater quantity by basing WQDS volumes and flow rates around a fixed volume of water (e.g. the first one inch of rain) or a frequent/small storm event (e.g. 2-year storm event). In some embodiments, lateral flow through the filter media allows for a configuration that further targets ever smaller storms and the earliest pollutant laden stages within the “first flush” of a larger storm while increasing the pollutant loading area and improving performance and service life. In some embodiments, an overflow feature may also be included.

In addition to enabling pretreatment technologies within a rain garden application, the stormwater treatment systems and methods in accordance with the present disclosure also may facilitate a maintenance feature to further prolong service life. In some embodiments, the primary pollutant removal region trench may be stabilized by perimeter reinforcing inclusions within the adjoining regions, in the same fashion as described for the forebay chamber and the outlet chamber as described herein above. In some embodiments, permeable trench screens might be internally stabilized by conventional methods. The stabilized, permeable, subsurface primary pollutant removal region trench may allow for the removal and replacement of primary pollutant removal media particulates during maintenance operations while maintaining the stability of the trench walls. Primary pollutant removal media particulates, like lightweight ESCS and UL-FGA, may be removed by vacuum trucks.

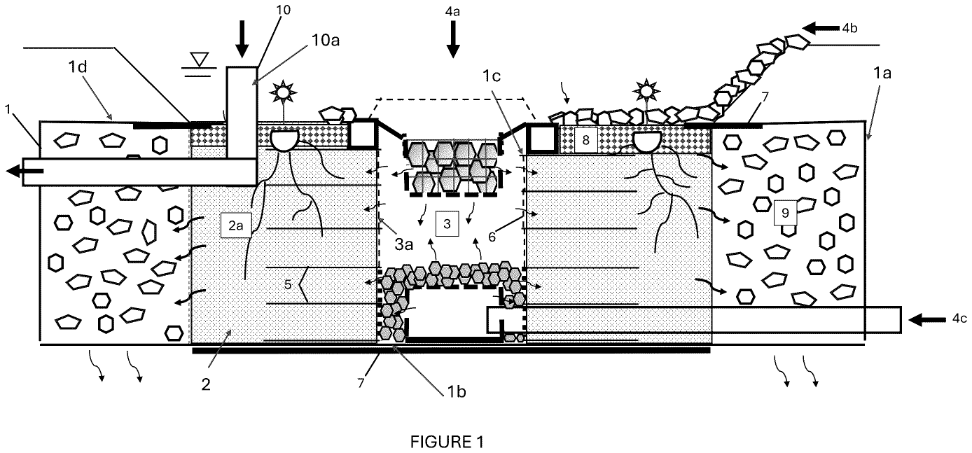

The above description can be implemented in various embodiments, some of which are described and illustrated in greater detail below. FIG. 1 is an elevation view illustrating a stormwater treatment system 1 according to some embodiments of the present disclosure.

In some embodiments, and as shown in FIG. 1, an excavation 1a of an underground volume sized for a predetermined volume of stormwater to be treated. In some embodiments, the volume is suitable for the anticipated SWQD design volume of stormwater to be treated. The excavation 1a is prepared having a generally level bottom or floor 1b. The top 1c of the stormwater treatment system 1 is set within a depression of the surface 1d such that water could pond above the stormwater treatment system 1.

In some embodiments, and as shown in FIG. 1, a stabilized filter media 2 may be deposited in a stabilized filter media region 2a the underground volume. In some embodiments, and as shown in FIG. 1, a stone bed and/or water storage containers of a storage/infiltration region 9 may be deposited in the underground volume. The excavation 1a may be backfilled with a stabilized filter media 2 and a forebay chamber 3 may be constructed within the filter media 2 to accept rainwater 4a, surface stormwater 4b and subsurface stormwater 4c from upstream pipes. In some embodiments, and as shown in FIG. 1, the forebay chamber 3 is formed in the underground volume surrounded by the stabilized filter media 2, which in turn is surrounded by the storage/infiltration region 9.

The forebay chamber 3 has permeable, stabilized vertical or near vertical chamber walls, which are subsurface walls. In some embodiments, and as shown in FIG. 1, the vertical or near vertical subsurface chamber walls 3a of the forebay chamber 3 may be stabilized with reinforcement inclusions 5 within the filter media 2. As shown in FIG. 1, the forebay chamber 3 may have an open top to permit entry of stormwater. In some embodiments, the reinforcement inclusions 5 may have an open mesh structure to allow for the unobstructed flow of the stormwater and entanglement with potential root systems. The reinforcement inclusions 5 may have a “wrap face” 6 at the vertical chamber wall face to retain the filter media 2. The “wrap face” 6 may include meshes or screens to further filter pollutants as desired.

When the surface area of the chamber walls 3a of the forebay chamber 3 is added to the surface area of the planting bed area of the rain garden, the pollutant load is spread across a larger surface area, which can provide benefits such as increasing the design service life, increasing the flow rate, reducing the footprint, and extending the maintenance schedule.

The chamber walls 3a of the forebay chamber 3 may be configured to support a surface inlet grate, and imposed loads, that screens large pollutants. Rip-Rap rocks may be placed above the stormwater treatment system 1 to protect against erosion.

In some embodiments, and as shown in FIG. 1, an impermeable geomembrane 7 may be placed on the floor 1b of the forebay chamber 3 to prevent erosion and enable maintenance crews to remove sediment and pollutants efficiently. The geomembrane 7 may be extended beyond the limits of the forebay chamber 3 to ensure a sufficient flow distance to remove pollutants before infiltrating into the subgrade, if required. Likewise, the geomembrane 7 may be placed on the surface 1d in transition areas to ensure stormwater passes through the filter media. Like the geomembrane on the floor 1b, the geomembrane 7 on the surface 1d in the transition area ensures a sufficient flow distance to remove pollutants. The transition zone may be located in an area of the interface between the primary pollutant removal region and the residual pollutant removal region. The geomembrane 7 may be positioned such that surface water cannot “short circuit” the treatment process by flowing only partially though the primary pollutant removal region.

In some embodiments, and as shown in FIG. 1, a planting bed region 8 may be planted and located above the filter media 2 to support vegetation. A storage/infiltration region 9 may extend laterally around a perimeter of the region of filter media 2 and be lined on the sides and top with a geotextile to prevent in-situ soil from piping into the stormwater treatment system 1. In some embodiments, the storage/infiltration region 9 may include at least one of open graded stone, aggregate, or water storage containers. This storage/infiltration region 9 collects the stormwater that passes through the stabilized filter media 2. The collected stormwater is stored while it infiltrates, evapotranspires, or is routed downstream from the storage/infiltration region 9. The region of stabilized filter media 2 and the storage/infiltration region 9 are configured to cause water to flow radially (e.g., outwardly) with respect to the forebay chamber 3 through the region of stabilized filter media 2 and the storage/infiltration region 9.

Stormwater may flow into the forebay chamber 3 though a surface grate or inlet pipe. Pretreatment materials and mechanisms may be installed within the forebay chamber 3 to remove pollutants. The WQDS volume infiltrates into the subgrade. Stormwater rising to the overflow elevation 10, typically associated with the WQDS volume, overtops into an overflow standpipe 10a and may be transported downstream.

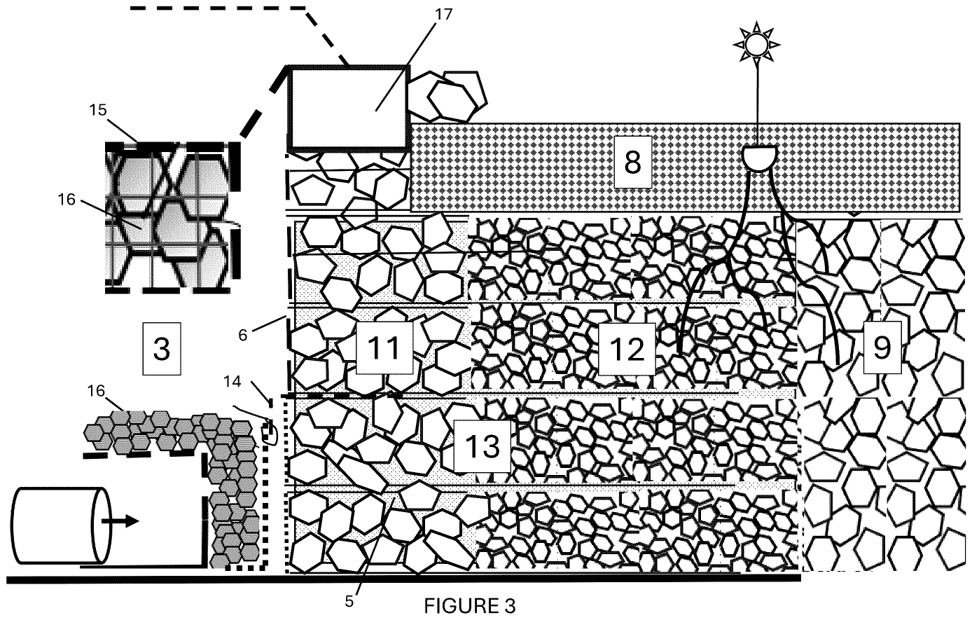

FIG. 3 provides an expanded view of the forebay chamber 3 and multiple surrounding filter media regions with dissimilar properties in accordance with some embodiments of the present disclosure. In some embodiments, and as shown in FIG. 3, behind the chamber wall face is the pretreatment pollutant removal region 11, which may be comprised of larger filter media particles. The filter media in the pretreatment pollutant removal region 11 may have a higher hydraulic conductivity and may be less likely to occlude while providing limited pollutant removal. Behind the pretreatment pollutant removal region 11 is a primary pollutant removal region 12, which may be comprised of relatively smaller filter media particles (in comparison to the larger filter media particles of the pretreatment pollutant removal region 11). The filter media in the primary pollutant removal region 12 may have a lower hydraulic conductivity and higher pollutant removal properties. Behind the primary pollutant removal region 12 is a storage/infiltration region 9 which may provide limited residual pollutant removal and may expand the infiltration footprint and storage capacity of the stormwater treatment system 1. In some embodiments, the storage/infiltration region 9 may include at least one of open graded stone (e.g., stone bed), aggregate, sand, or water storage containers.

The interface between the pretreatment pollutant removal region 11 and the primary pollutant removal region 12 has a pollutant load surface area 13. The pollutant load surface area 13 may be targeted in test protocols to measure any decreases of flow rate over time related to occlusion. As the length of the pretreatment pollutant removal region 11 increases, more pollutants may be removed and the pollutant load reaching the pollutant load surface area may decrease. Also, and importantly, the pollutant load surface area 13 increases significantly with the lengthening of the pretreatment pollutant removal region 11, which may reduce the pollutant load concentration reaching the interface between the pretreatment pollutant removal region 11 and the primary pollutant removal region 12. An expanded pollutant load surface area 13 may reduce the potential for clogging. Also, the larger interface between the pretreatment pollutant removal region 11 and the primary pollutant removal region 12 may increase the flow capacity through the primary pollutant removal region 12, which may enable continuous lateral flow from the forebay chamber 3 into the storage/infiltration region 9 without creating a choke point.

In some embodiments, and as shown in FIG. 3, a removable filter screen 14 at the wall face of the forebay chamber 3 may be attached to reinforcement inclusions 5 anchored within pretreatment pollutant removal region 11 and/or primary pollutant removal region 12. Additional reinforcement inclusions 5 may be inserted for this purpose. This may simplify maintenance, prolong service life, and improve pretreatment pollutant removal by enabling the use of a finer screen that is replaceable.

In some embodiments, and as shown in FIG. 3, the stormwater treatment system 1 may include a catch basin insert 15 and pollutant targeting granules or pollutant targeting materials 16 within the forebay chamber 3 to provide further pretreatment pollutant removal. In some embodiments, pollutant targeting materials 16 may include open-cell foam eelgrass. The inlet elevation of a surface grate foundation 17 may be adjusted to meet design objectives. An inlet set at or below the rain garden surface can direct the earliest influent containing the highest pollutant load and concentration (e.g. salt, heavy metals, or the like) into the forebay chamber 3 for targeted treatment. Conversely, the surface grate foundation 17 elevation can be raised to maximize the surface water volume and optimize the saturation of the planting bed region 8 especially during small storm events. These materials and their placement in a submerged, stabilized, porous forebay chamber 3 within a rain garden as described in accordance with the present disclosure is unique.

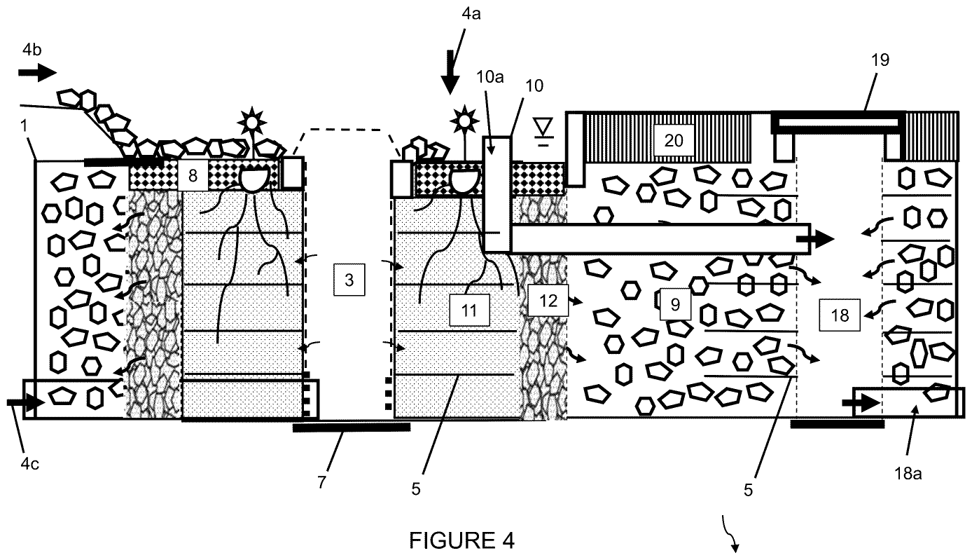

FIG. 4 provides a plan view of stormwater treatment system 1 with a forebay chamber 3 receiving surface stormwater 4b and subsurface stormwater 4c through an inlet grate and pipes respectively. The forebay chamber 3 is surrounded by a pretreatment pollutant removal region 11 stabilized by reinforcement inclusions 5 that may extend further (e.g., laterally) if required. In turn, the pretreatment pollutant removal region 11 is surrounded by the primary pollutant removal region 12 and the storage/infiltration region 9. The regions surrounding the forebay chamber 3 may be designed to provide the required pollutant removal capacity, flow capacity, and storage volume.

In some embodiments, and as shown in FIG. 4, the stormwater treatment system 1 may include an outlet chamber 18. The outlet chamber 18 is formed at a location spaced from the forebay chamber 3. The outlet chamber 18 may be stabilized by reinforcement inclusions 5 and may be incorporated into the storage/infiltration region 9. A solid manhole cover 19 may be placed above the outlet chamber 18, essentially flush with the top of a road/parking lot surface 20. The WQDS stormwater volume may flow through the subsurface and into the outlet chamber 18 through the stabilized and permeable walls of the outlet chamber 18.

The overflow standpipe 10a may be installed within the rain garden pond at an overflow elevation 10, typically set at the WQDS volume, to direct water to the outlet chamber 18. An upstream diversion manhole designed to delineate stormwater flows may also redirect stormwater to the outlet chamber 18. The storage/infiltration region 9 may be expanded to store additional stormwater as needed.

The dimensions of the outlet chamber 18 may be sized to ensure adequate flow through the face of the outlet chamber 18. In some embodiments, and as shown in FIG. 4, an outlet pipe 18a may be connected to the outlet chamber 18 to transport treated stormwater from the outlet chamber 18 downstream, typically to an outlet control structure.

Geomembranes 7, or other suitable material, may be placed on the floor 1b of the forebay chamber 3 and outlet chamber 18 to facilitate maintenance. If the stormwater treatment system 1 is designed to infiltrate stormwater into the subgrade, the geomembrane 7 or impermeable material below the forebay chamber 3 may be extended across the floor 1b as needed. In applications where the subgrade is deemed impermeable there would be no need to extend the geomembrane 7.

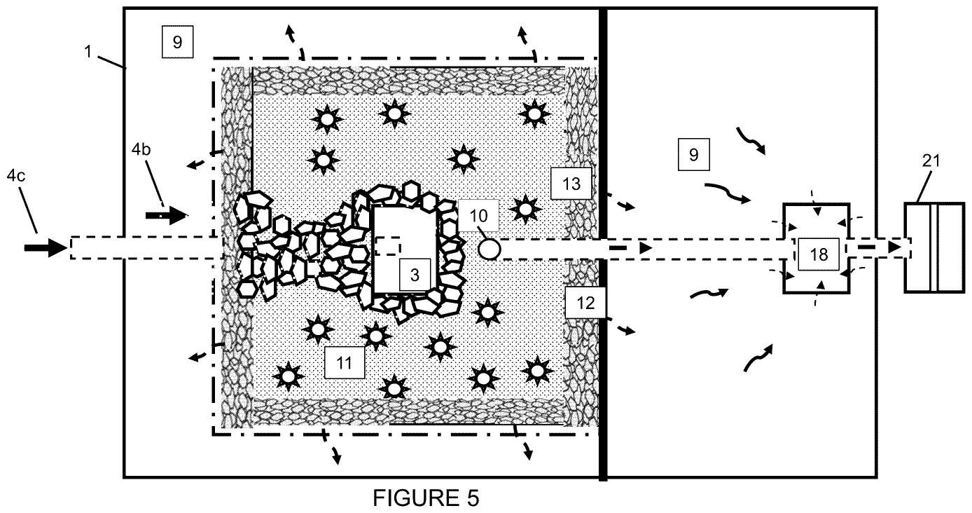

FIG. 5 is a plan view of the stormwater treatment system 1 shown in FIG. 4 along with an outlet control structure 21 located downstream of the outlet chamber 18. The outlet control structure 21 is configured to regulate flows to downstream outlets. FIG. 5 illustrates how increases in the footprint of the pretreatment pollution removal region 11 may increase the pollutant load capacity of the pretreatment pollution removal region 11 and may expand the pollutant load surface area 13 at the interface with the primary pollutant removal region 12.

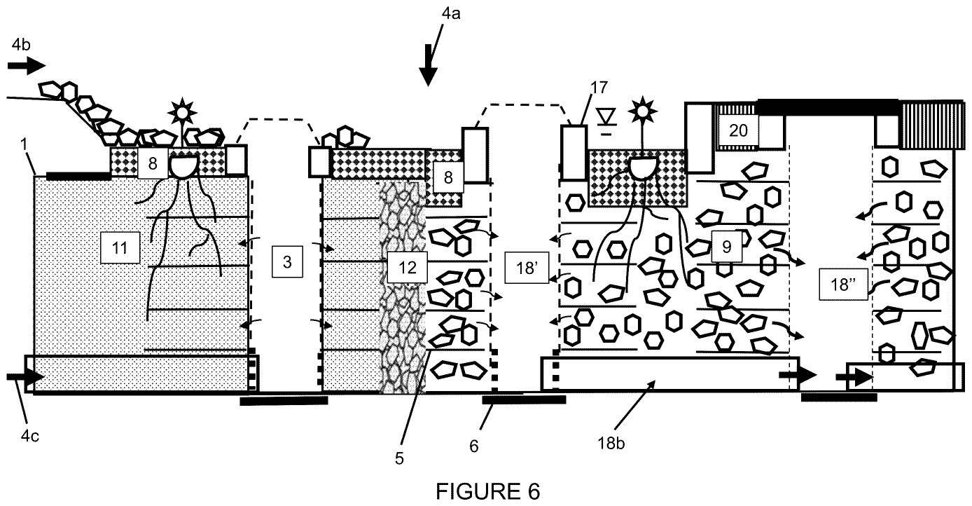

FIG. 6 illustrates the stormwater treatment system 1 in accordance with some embodiments of the present disclosure. In some embodiments, and as shown in FIG. 6, the primary pollutant removal region 12 may be positioned as a wall running the width of the stormwater treatment system 1 bisecting the pretreatment pollutant removal region 11 and the storage/infiltration region 9.

The planting bed region 8 may sit within the surface pond and above both the pretreatment pollutant removal region 11 and the primary pollutant removal region 12, and the storage/infiltration region 9. The planting bed region 8 above the storage/infiltration region 9 may have a deeper profile if required for pollutant removal.

In some embodiments, and as shown in FIG. 6, two outlet chambers 18 may be incorporated in the stormwater treatment system 1. A first outlet chamber 18′ may be located within the rain garden surface pond and the storage/infiltration region 9. Treated stormwater flowing through the primary pollutant removal region 12 can flow into the first outlet chamber 18'. The surface inlet elevation for the first outlet chamber 18′ is set at an overflow elevation 10 within the pond typically associated with the WQDS volume and replaces the overflow standpipe. In some embodiments, and as shown in FIG. 6, a second outlet chamber 18″ may be located below a road/parking lot surface 20, and may collect water from an inlet pipe 18b connected to the first outlet chamber 18′ and from the storage/infiltration region 9 and transports treated stormwater downstream.

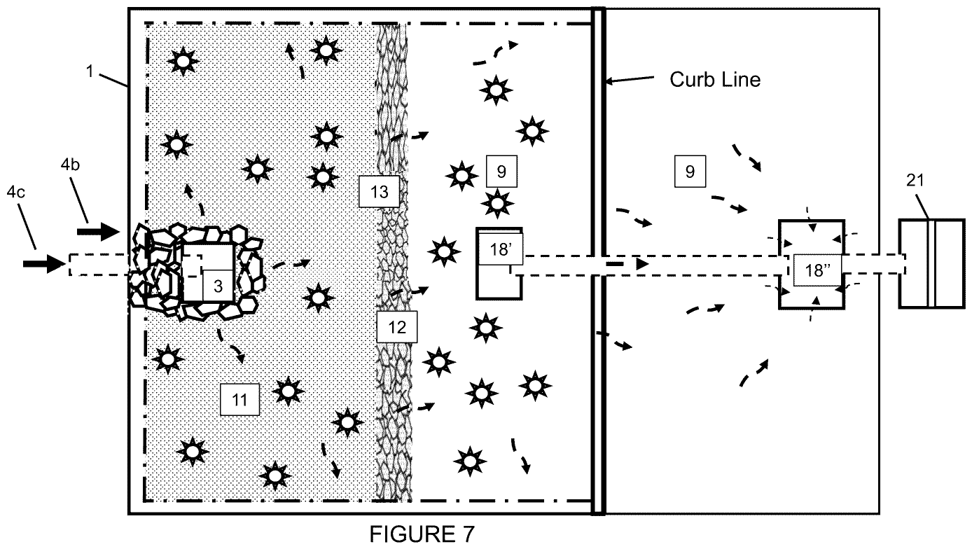

FIG. 7 provides a plan view of the stormwater treatment system 1 shown in FIG. 6 illustrating the primary pollutant removal region 12 bisecting the pretreatment pollutant removal region 11 and the storage/infiltration region 9. The curb line delineates the rain garden pond from the parking lot on the surface. The relative positions of the forebay chamber 3, first outlet chamber 18′ within the surface pond, the second outlet chamber 18″ within the road/parking lot, and the outlet control structure 21 are shown.

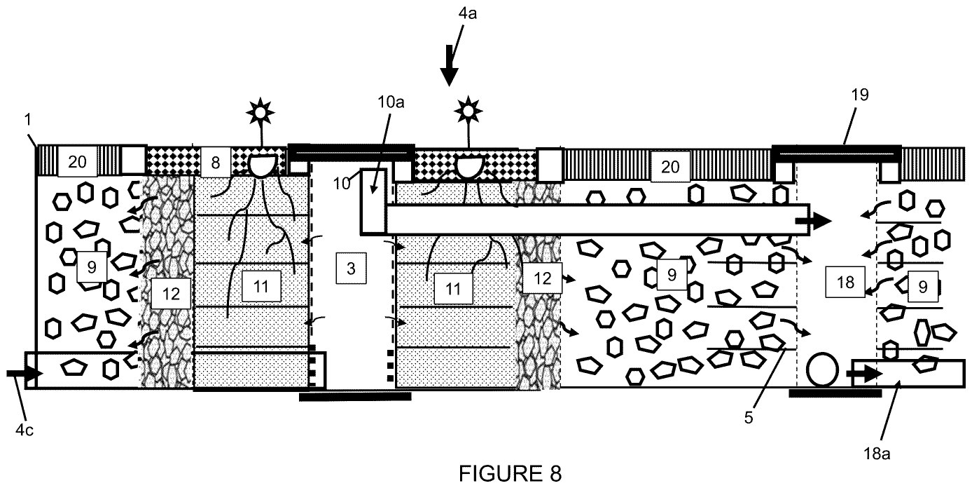

FIG. 8 shows a stormwater treatment system 1 in accordance with some embodiments of the present disclosure. FIG. 8 shows a rain garden within a parking lot. In FIG. 8, planting bed regions 8 are separated from road/parking lot surface 20 by curbs. Subsurface stormwater 4c may be piped into the forebay chamber 3, since there is no surface pond. A solid manhole covers 19 may sit atop the forebay chamber 3 and the outlet chamber 18. The overflow elevation 10, typically associated with the WQDS volume, is set at the top of the overflow standpipe 10a within the forebay chamber 3, as is shown, for example, in FIG. 8. The WQDS volume may be transported to the outlet chamber 18 though the pretreatment pollutant removal region 11, the primary pollutant removal region 12, and the storage/infiltration region 9. Stormwater overflowing into the overflow standpipe 10a may be transported to the outlet chamber 18. The outlet chamber 18 may receive inflow from more than one forebay chamber 3. The outlet chamber 18 is configured to distribute stormwater into the storage/infiltration region 9 for infiltration if the subgrade is considered permeable. The outlet chamber 18 may transport water downstream, typically through an outlet pipe 18a to the outlet control structure 21. Regulated outflow from the outlet control structure 21 can result in water backing up into the outlet chamber 18 and storage/infiltration region 9 where it can be retained during the storm event. The outlet chamber 18 and the storage/infiltration region 9 may function as a retention system servicing the quantity component of the stormwater management system much like described in U.S. Pat. No. 7,473,055B2 , which is incorporated herein by reference in its entirety. The outlet chamber 18 and storage/infiltration region 9 may be sized appropriately.

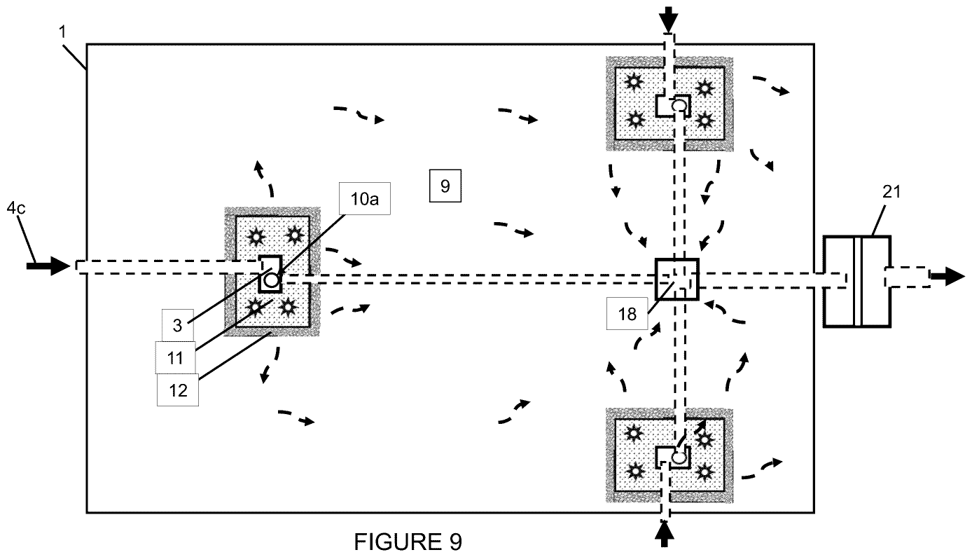

FIG. 9 provides a plan view of the stormwater treatment system 1 shown in FIG. 8 illustrating multiple stormwater treatment systems 1 located within a parking lot in accordance with some embodiments of the present disclosure. Overflow standpipes 10a are located within the forebay chambers 3. Subsurface flow may transport stormwater from the forebay chambers 3 to the outlet chamber 18. Overflow from the forebay chamber 3 also may be directed to the outlet chamber 18 though a pipe. The outlet chamber 18 may direct water to the outlet control structure 21 and can supply stormwater into the storage/infiltration region 9 for infiltration and/or storage.

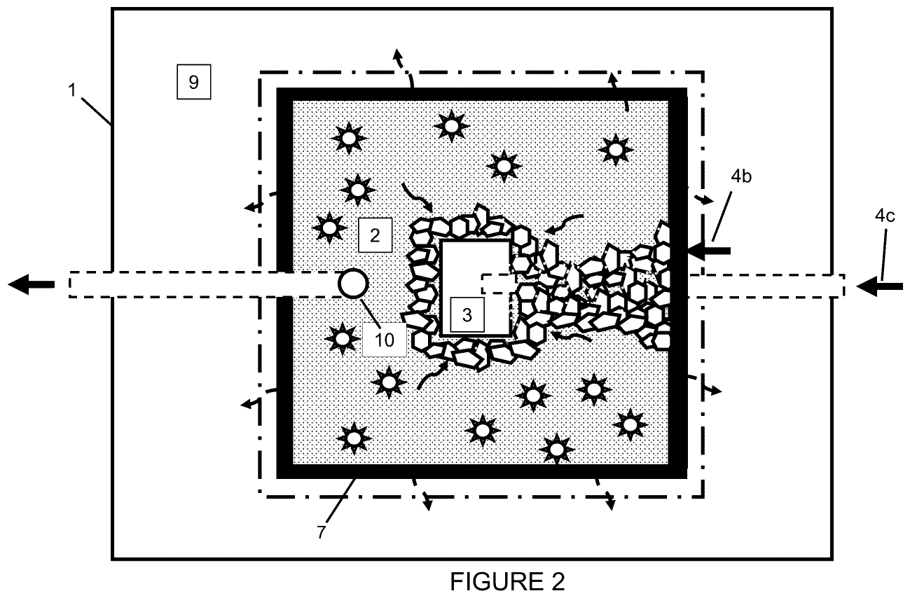

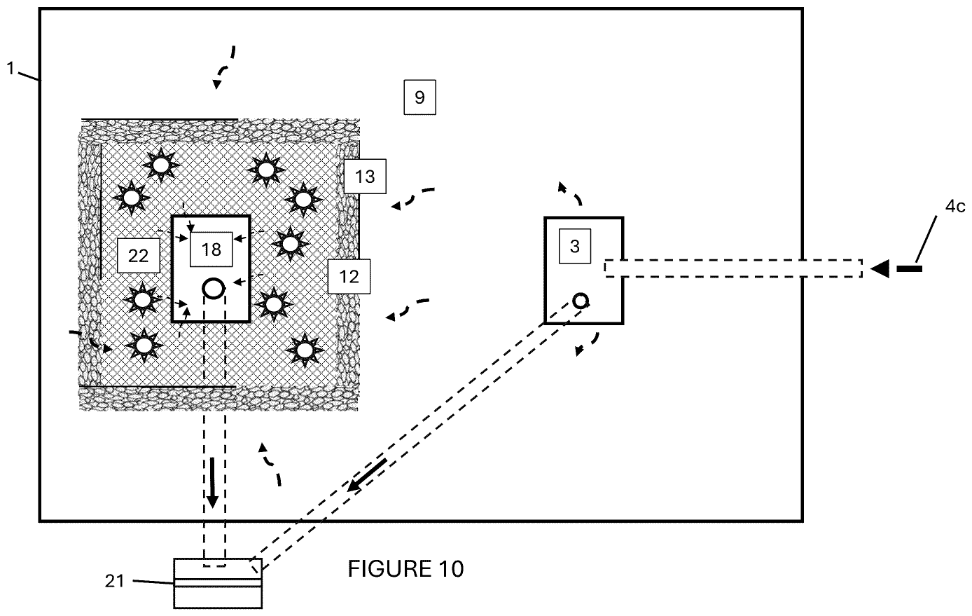

FIG. 10 is a plan view of a stormwater treatment system 1 in accordance with some embodiments of the present disclosure. FIG. 10 illustrates a reverse stormwater flow direction to that described hereinabove with respect to FIGS. 1-9. In FIG. 10, the forebay chamber 3 is located within the storage/infiltration region 9, and the outlet chamber 18 is located within the rain garden. The forebay chamber 3 and outlet chamber 18 may each have a standpipe within their chambers set at the overflow elevation 10, similar to overflow elevation 10 and overflow standpipe 10a shown in FIG. 8, and directed to the outlet control structure 21. The configuration shown in FIG. 10 has an advantage of enabling a very large pollutant load surface area 13. In the embodiment show in FIG. 10, the pollutant load surface area 13 is located between the storage/infiltration region 9 and the primary pollutant removal region 12. A residual pollutant removal region 22 surrounding the outlet chamber 18 can be comprised of stone or filter media as is necessary to meet the design requirements.

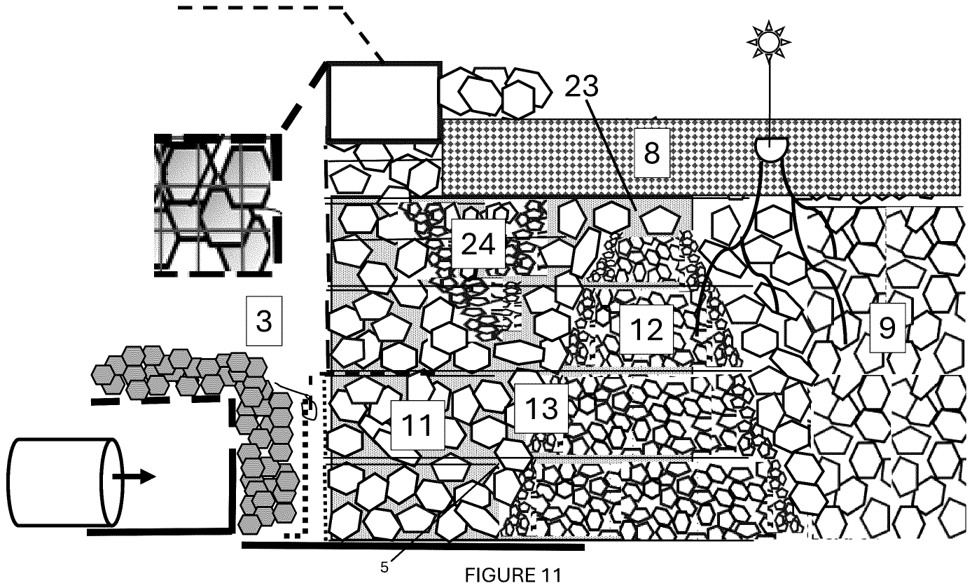

FIG. 11 is an elevation view similar to FIG. 3, illustrating an alternate configuration of the filter media regions that offers unique benefits. In comparison to FIG. 3, the primary pollutant removal region 12 shown in FIG. 11 is wider at the base and narrows upwardly with height. The shape of the primary pollutant removal region 12 shown in FIG. 11 increases the pollutant load surface area 13 in comparison to the pollutant load surface area 13 shown in FIG. 3. Also, the shape of the primary pollutant removal region 12 shown in FIG. 11 introduces a vertical component to the flow through the primary pollutant removal region 12.

The wide base of the primary pollutant removal region 12 may increase the pollutant load capacity at the bottom of the primary pollutant removal region 12. Stormwater treatment systems 1 are configured to collect the pollutants deposited on the surface of the upstream watershed. Small frequent storms, often much smaller than the WQDS volume, carry the largest volume of pollutants. In larger storms (e.g., 25-year storm event) the early stage of the storm carries the highest concentration of pollutants which is the basis for developing a WQDS treatment volume. Following the same logic, the earlies stages of the WQDS event carry a higher pollutant load. For example, if the WQDS volume is based on the first 1.25 inches of rain in a large storm event, the first 0.25 inches of stormwater inflow will likely have a higher pollutant concentration than the stormwater that follows. The wide base of the primary pollutant removal region 12 may provide a higher pollutant load capacity (in comparison to a primary pollutant removal region with vertical or near vertical sides) and aligns with the pollutant concentrations in small storms and the early stages of large storms. The wide base may slow the flow rate, but that may improve pollutant removal and can be checked against the required draw down time, typically 48-92 hours. In addition, in larger storms the lower flow rate though a wider width may be offset, to some degree, by a higher hydraulic gradient at the floor of the stormwater treatment system 1. These competing factors may be balanced to optimize the materials and configuration of the primary pollutant removal region 12.

In some embodiments, and as shown in FIG. 11, at higher elevations in the primary pollutant removal region 12, the width decreases which may provide less pollutant loading capacity and increase the flow rate. The pollutant load concentration may be lower at these higher elevations as the pollutant load decreases in the later stages of the storm event. The primary pollutant removal region 12 configuration and the pollutant loading characteristics of storm events may be aligned.

In some embodiments, the primary pollutant removal region 12 may extend to the planting bed region 8. In some embodiments, and as shown in FIG. 11, a primary pollutant removal region overflow pathway 23 may be present at the top of the primary pollutant removal region 12 for overflow. The primary pollutant removal region overflow pathway 23 may be set at the elevation corresponding to the WQDS volume and acts as a safeguard against clogging.

Furthering the optimization of pollutant removal, while maintaining an overflow component, FIG. 11 includes an inverted primary pollutant removal region 24. The inverted primary pollutant removal region 24, located immediately below the planting bed region 8, may be configured to intercept stormwater flowing laterally before it enters the primary pollutant removal region overflow pathway 23. Pollutants may be removed within the inverted primary pollutant removal region 24 or redirected on a longer, more tortious flow path through the pretreatment pollutant removal region 11 before entering the storage/infiltration region 9.

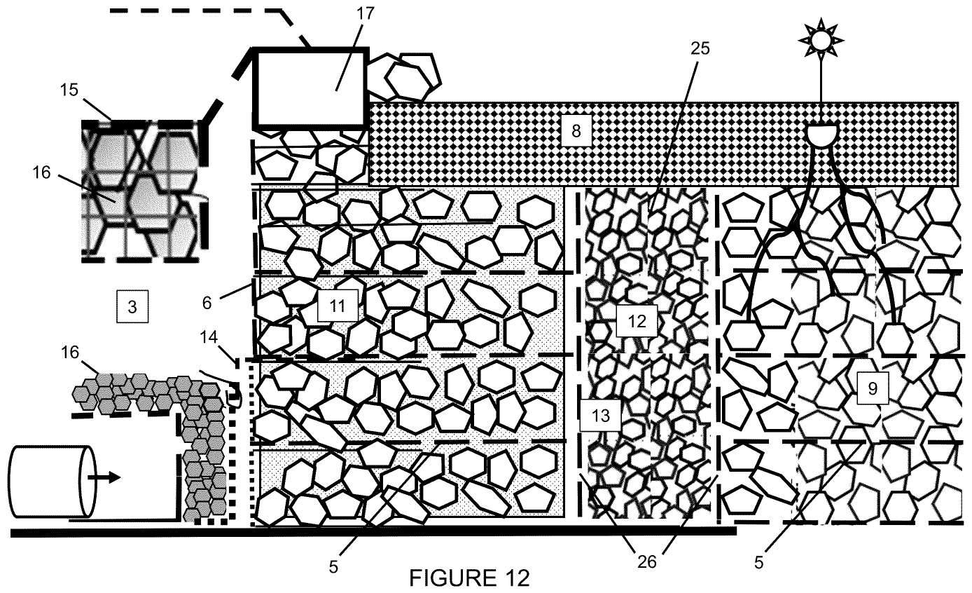

FIG. 12 is an elevation view similar to FIG. 3, illustrating a stabilized, permeable, subsurface self-supporting trench 25 configured to house a filter media of the primary pollutant removal region 12. Reinforcement inclusions 5 stabilize the pretreatment pollutant removal region 11 and storage/infiltration region 9 on both sides of the subsurface self-supporting trench 25, which has trench walls 26 which may be vertical walls. “Wrap face” wall techniques may be employed at the face of the trench walls 26 to retain the filter media within the pretreatment pollutant removal region 11 and retain aggregate in the storage/infiltration region 9. A stabilized, permeable, subsurface self-supporting trench 25 may enable the removal and replacement of the primary pollutant removal filter media with minimal disruption to the planting bed region 8 or stormwater treatment system 1. Filter media particulates may be removed with a vacuum truck. In some embodiments, and as shown in FIG. 12, the subsurface self-supporting trench 25 may be filled with a second filter media that is separate from the filter media in the pretreatment pollutant removal region 11 surrounding the forebay chamber 3.

While the foregoing is directed to embodiments of the present disclosure, other and further embodiments of the disclosure may be devised without departing from the basic scope thereof.

1. A stormwater treatment system, comprising:
a first chamber having stabilized, permeable, subsurface chamber walls;
a stabilized filter media region surrounding the first chamber; and
a storage/infiltration region surrounding the stabilized filter media region,
wherein the stabilized filter media region and the storage/infiltration region are configured to cause water to flow radially with respect to the first chamber through the stabilized filter media region and the storage/infiltration region.

2. The system of claim 1, wherein the storage/infiltration region includes at least one of open graded stone, aggregate, sand, or water storage containers.

3. The system of claim 1, further comprising an impermeable geomembrane at a bottom of the first chamber.

4. The system of claim 1, further comprising at least one of:
an inlet grate or manhole cover supported by the chamber walls;
a catch basin insert or pollutant targeting granules or materials within the first chamber; or
a screen at a face of the chamber walls sized to filter particulates.

5. The system of claim 1, wherein the filter media region includes a pretreatment pollutant removal region comprised of filter media particles of a first size and a primary pollutant removal region comprised of filter media particles of a second size, wherein the first size is larger than the second size.

6. The system of claim 5, wherein the primary pollutant removal region surrounds the pretreatment pollutant removal region.

7. The system of claim 5, wherein the primary pollutant removal region is surrounded by a trench that is stabilized and self-supporting.

8. The system of claim 1, wherein the filter media region includes a plurality of regions of different gradations, flow rates, and pollutant removal properties.

9. The system of claim 1, further comprising inclusions extending at least partially into at least one of the filter media region or the storage/infiltration region.

10. The system of claim 9, wherein the inclusions are formed from geosynthetic materials.

11. The system of claim 1, further comprising a planting bed region atop the filter media region and/or the storage/infiltration region.

12. The system of claim 11, wherein the first chamber is configured to bottom feed vegetation roots with water and oxygen.

13. The system of claim 1, further comprising a second chamber formed in a stone bed at a location spaced from the first chamber, the second chamber having permeable stabilized walls.

14. The system of claim 13, wherein the walls of the first chamber and the walls of the second chamber are supported by at least one of geosynthetic materials, gabions, or geocellular structures.

15. The system of claim 1, further comprising:
a region of filter media forming permeable stabilized walls of a second chamber, wherein the region of filter media is surrounded by a stone bed, and wherein the second chamber is spaced from the first chamber.

16. A method of constructing a stormwater treatment system, comprising:
excavating an underground volume sized for a predetermined volume of stormwater to be treated;
forming a forebay chamber in the underground volume, the forebay chamber having permeable, stabilized vertical or near vertical chamber walls;
depositing a filter media surrounding the forebay chamber; and
depositing a stone bed and/or water storage containers surrounding the filter media.

17. The method of claim 16, wherein the filter media includes a plurality of regions of different gradations, flow rates, and pollutant removal properties establishing a flow path radially outward from the forebay chamber through the filter media and to the stone bed and/or water storage containers.

18. The method of claim 16, further comprising at least one of:
planting a planting bed region atop at least one of the filter media or the stone bed;
placing at least one of a catch basin insert or pollutant targeting granules or materials within the forebay chamber;
placing an inlet grate or manhole cover supported by the chamber walls; or
installing screens on the chamber walls.

19. The method of claim 16, further compromising:
forming and stabilizing a self-supporting trench between the filter media and the stone bed and/or water storage containers, the trench having vertical or near vertical walls; and
filling the trench with a second filter media that is separate from the filter media surrounding the forebay chamber.

20. The method of claim 16, further comprising:
forming an outlet chamber within the stone bed at a location spaced from the forebay chamber, the outlet chamber having permeable vertical or near vertical walls defining an outlet chamber, wherein the walls of the outlet chamber are stabilized. wherein the filter media includes a plurality of regions of different gradations, flow rates, and pollutant removal properties establishing a flow path from the forebay chamber, through the filter media, to the outlet chamber.
